(19) United States
(12) Patent Application Publication
(10) Pub. No.: US 2008/0131130 A1
(43) Pub. Date: Jun. 5, 2008

(54) OPTICAL NETWORK NODE DEVICE

(75) Inventors: Sun Hyok CHANG, Daejeon-city (KR); Hwan Seok CHUNG, Daejeon-city (KR); Sang Soo LEE, Daejeon-city (KR); Kwangjoon KIM, Daejeon-city (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejeon-city (KR)

(21) Appl. No.: 11/947,336

(22) Filed: Nov. 29, 2007

(30) Foreign Application Priority Data
Dec. 5, 2006 (KR) 10-2006-0122554
Oct. 2, 2007 (KR) 10-2007-0099368

(51) Int. Cl. H04J 14/02

(52) U.S. Cl. 398/83

(57) ABSTRACT

Provided is an optical network node device. According to the optical network node device, a planar lightwave circuit (PLC) based or a blocker based 4-terminals ROADM can be used in a node of at least degree 3, a proceeding direction of a wavelength channel can be changed in an electrical cross connect switch, and transmission in a unit smaller than a wavelength channel can be cross connected, dropped, and added, or transmission capacity can be redistributed in the electrical cross connect switch. Accordingly, efficient transmission in a small capacity and large capacity transmission of a wavelength channel can be performed simultaneously, and thus an optical network can be effectively managed. Also, since the node of at least degree 3 uses the PLC based or a blocker based reconfigurable optical add drop multiplexer (ROADM), the node of at least degree 3 can use the same ROADM module as a node of degree 2. Accordingly, the optical network node device has an advantage in manufacturing and managing a node.

### CROSS-REFERENCE TO RELATED PATENT APPLICATION

This application claims the benefit of Korean Patent Application Nos. 10-2006-0122554, filed on Dec. 5, 2006, and 10-2007-0099368, filed on Oct. 2, 2007, in the Korean Intellectual Property Office, the disclosures of which are incorporated herein in their entirety by reference.

### BACKGROUND OF THE INVENTION

1. Field of the Invention

The present invention relates to a network, and more particularly, to an optical network node using a reconfigurable optical add drop multiplexer (ROADM).

The present invention is supported by the IT R&D program of MIC/IITA. [2006-S-059-01, ASON based Metro Photonic Cross-Connect Technology]

2. Description of the Related Art

A wavelength division multiplexing (WDM) optical transmission technology is on the rise as a solution for satisfying remarkable increase of demand for high transmission capacity. The WDM optical transmission technology can simultaneously transmit several wavelength channels in one optical fiber. For example, when one wavelength channel has transmission speed of 10 Gb/s and 50 wavelengths are simultaneously transmitted, the WDM optical transmission technology can have transmission speed of 500 Gb/s, and thus the WDM optical transmission technology is very effective in large capacity transmission.

In an optical network, which uses the WDM optical transmission technology, a wavelength channel needs to be added or dropped in a network node in order to increase efficiency and variability of the optical network. A predetermined wavelength channel can be added/dropped in a predetermined node by using a fixed optical add drop multiplexer (F-OADM) technology. A reconfigurable optical add drop multiplexer (ROADM) technology is required for efficiency of the optical network, and also in order to economically use network resources. When the ROADM technology is used, a predetermined channel can be added/dropped in a predetermined node, and thus an efficient network operation is possible.

FIG. 1 is a conceptual diagram illustrating a 4-terminals ROADM. Generally, an ROADM is a 4-terminals device, wherein input and output optical fibers each include two ports (port s) and drop and add optical fibers each include two ports. Also, the ROADM has an optical output control function.

Currently, 3 technologies from among ROADM technologies are practical, and can be commercialized. The 3 technologies are a planar lightwave circuit (PLC) based ROADM, a blocker based ROADM, and a wavelength selective switch (WSS) based ROADM.

FIG. 2 is a diagram illustrating a PLC based ROADM. A PLC is a silicon-chip technology, which provides a base for manufacturing several optical devices on one circuit board. Here, devices such as a 2×1 switch, a variable optical attenuator (VOA), and a tap can be integrally manufactured on one circuit board in a chip level.

Referring to FIG. 2, a part of WDM optical power is separated and passes through a demux-AWG 200. Then, the part of WDM optical power is separated to each wavelength channel, and a required drop wavelength channel can be selected. The part of WDM optical power passes through a ROADM 210, and is separated into each wavelength channel by passing through the demux-AWG 200. 2×1 switches are located in each path of the wavelength channels, and determine whether to pass through a received wavelength channel or an added signal. A pass through direction of the wavelength channel can be selected by the 2×1 switch, and adding of a wavelength channel can be easily done.

FIG. 3 is a diagram illustrating a blocker based ROADM. A blocker 300 is located in a path of WDM wavelength channels, and the blocker 300 can selectively block certain wavelength channels. A part of WDM optical power, which is an input wavelength, passes through a splitter 310 and a fixed/tunable filter 320, and the wavelength channels can be selectively dropped. In an add direction, a desired wavelength channel can be added by using a transmitter (Tx) 330, which uses a fixed or tunable laser. The blocker 300 does not effect a passing through wavelength channel and blocks an added or dropped wavelength channel.

The PLC based ROADM of FIG. 2 and the blocker based ROADM of FIG. 3 are a 4-terminals device, as shown in FIG. 1.

A WSS includes one input port and a plurality of output ports, and can output a predetermined wavelength channel to a predetermined output port. Alternatively, the WSS includes a plurality of input ports and one output port, and can output a wavelength channel inputted from a predetermined input port to the output port.

FIG. 4 is a diagram illustrating a WSS based ROADM. According to the WSS based ROADM, a desired wavelength channel from among inputted WDM wavelength channels can be dropped to a certain port. Express wavelength channels other than the dropped wavelength channels pass through a predetermined output port, and then are connected to an input port of a second WSS 410. The second WSS 410 combines pass through wavelength channels from a first WSS 400 and add wavelength channels from each input port, and then outputs them to an output port.

In a WDM optical network, degree of a node is determined by the number of optical fibers inputted to the node. FIG. 5 is a diagram illustrating an optical network in a shape of two rings, wherein the rings are joined at a node 504. Each ring are connected by optical fibers in two directions 501 and 502 in order to support bidirectional transmission. A wavelength channel 506 is added/dropped in a ROADM node 505. Nodes 503 and 505 have two inputs for optical fibers, and thus called nodes of degree 2, and the node 504 has four inputs for optical fibers, and thus called a node of degree 4.

In a node of degree 2, such as the node 503 or 505, the three ROADM technologies described above can be used in order to add/drop the wavelength channel 506. However, in a node of degree 4, such as the node 504, only the WSS based ROADM can be applied.

Since the PLC based ROADM or the blocker based ROADM are basically a 4-terminals device, it is impossible to be connected to an optical fiber in a direction other than input/output. However, since the WSS based ROADM includes several input and output ports, one port can be used to be connected to an optical fiber in another direction.

FIG. 6 is a diagram illustrating an optical network node of degree 4 using a WSS based ROADM. A wavelength channel from among wavelength channels inputted to an east ROADM 600 is dropped through a drop port, and another wavelength channel, which needs to pass through another direction, is outputted to a port connected to an ROADM in the another direction. Similarly, a wavelength channel, that needs to pass through the east ROADM 600, from among wavelength channels inputted to another ROADM, is proceeded to the east ROADM 600 through a port connected to the east ROADM 600. The configuration of the ROADM of FIG. 6 can be used as the node 504 of FIG. 5.

The WSS based ROADM can be used in a node of at least degree 3, but is quite expensive compared to the PLC based or blocker based ROADM, and has weak durability. In other words, the PLC based or block based ROADM has several advantages, but cannot be applied in a node of at least degree 3.

### SUMMARY OF THE INVENTION

The present invention provides an optical network node device, which can support a node of at least degree 3 by using a planar lightwave circuit (PLC) based ROADM or a blocker based ROADM.

According to an aspect of the present invention, there is provided an optical network node device, including: a plurality of 4-terminals ROADM, which controls a wavelength division multiplexing (WDM) channel to pass through, drop, or pass through after adding an optically converted signal to the WDM channel; optical transceivers, which photoelectrically convert a signal dropped from a corresponding ROADM or optically convert an electric signal transmitted to a corresponding ROADM; and an electrical cross connect switch, which switches the signal that is photoelectrically converted by the optical transceiver to one of optical transceivers corresponding to a direction that the signal will pass through, by redistributing transmission capacity and cross connecting the signal so that the signal is transmitted to a corresponding ROADM.

According to another aspect of the present invention, there is provided an optical network node device, including: a plurality of 4-terminals ROADM, which controls a wavelength division multiplexing (WDM) channel to pass through, drop, or pass through after adding a part of an optically converted signal to the WDM channel; optical transceivers, which photoelectrically convert a part of a signal dropped from a corresponding ROADM or optically convert an electric signal transmitted to a corresponding ROADM; and an electrical cross connect switch, which switches the signal that is photoelectrically converted by the optical transceiver to one of optical transceivers corresponding to a direction that the signal will pass through, by redistributing transmission capacity and cross connecting the signal so that the signal is transmitted to a corresponding ROADM, wherein the ROADM outputs another part of the signal, excluding the part of the dropped signal and the part of the added signal, to outside of the optical network node device.

### BRIEF DESCRIPTION OF THE DRAWINGS

The above and other features and advantages of the present invention will become more apparent by describing in detail exemplary embodiments thereof with reference to the attached drawings in which:

FIG. 1 is a conceptual diagram illustrating a 4-terminals reconfigurable optical add drop multiplexer (ROADM);

FIG. 2 is a diagram illustrating a planar lightwave circuit (PLC) based ROADM;

FIG. 3 is a diagram illustrating a blocker based ROADM;

FIG. 4 is a diagram illustrating a wavelength selective switch (WSS) based ROADM;

FIG. 5 is a diagram illustrating an optical network in a shape of two rings, wherein the rings are joined at a node.

FIG. 6 is a diagram illustrating an optical network node of degree 4 using a WSS based ROADM;

FIG. 7 is a diagram illustrating an optical network node device according to an embodiment of the present invention; and

FIG. 8 is a diagram illustrating an optical network node device according to another embodiment of the present invention.

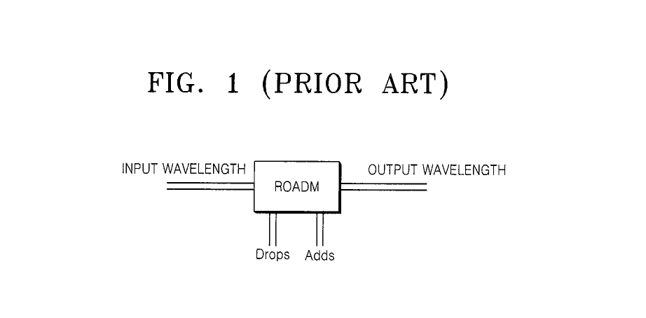

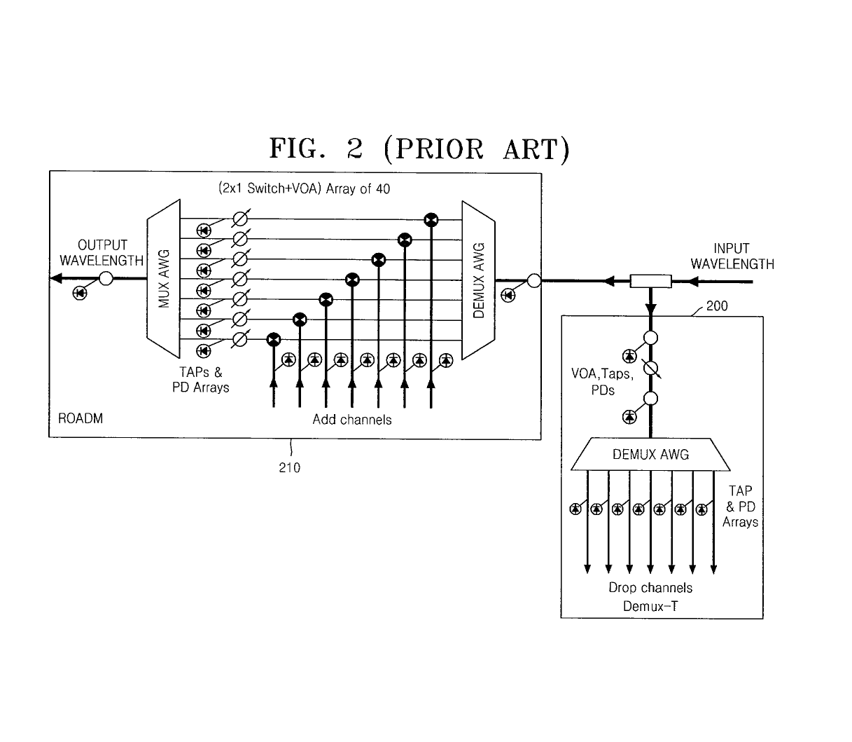

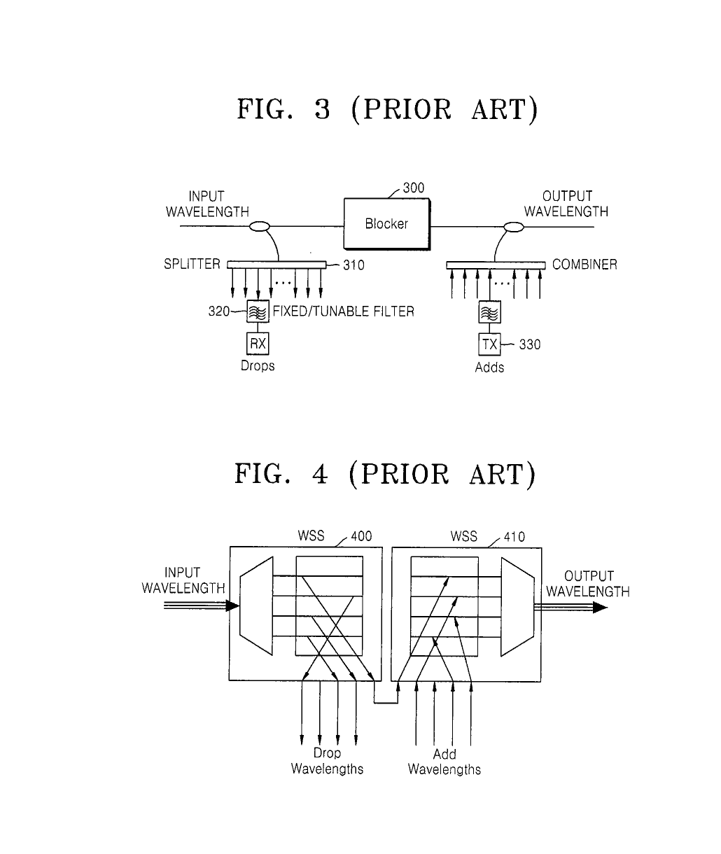

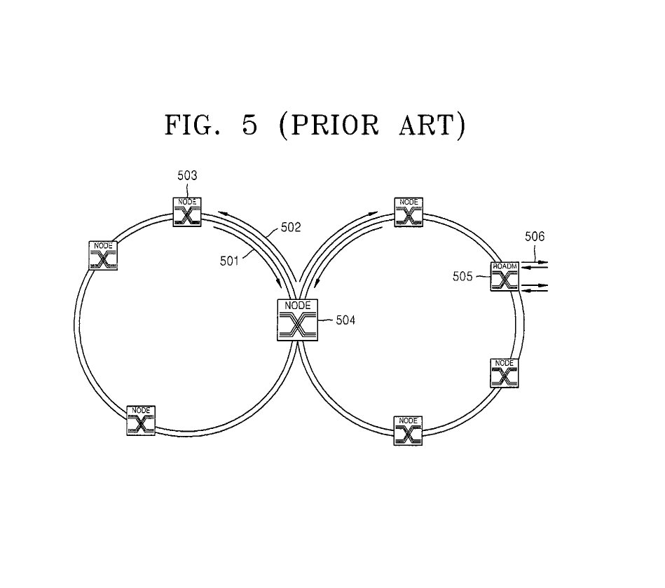

### DETAILED DESCRIPTION OF THE INVENTION

Hereinafter, the present invention will be described more fully with reference to the accompanying drawings, in which exemplary embodiments of the invention are shown.

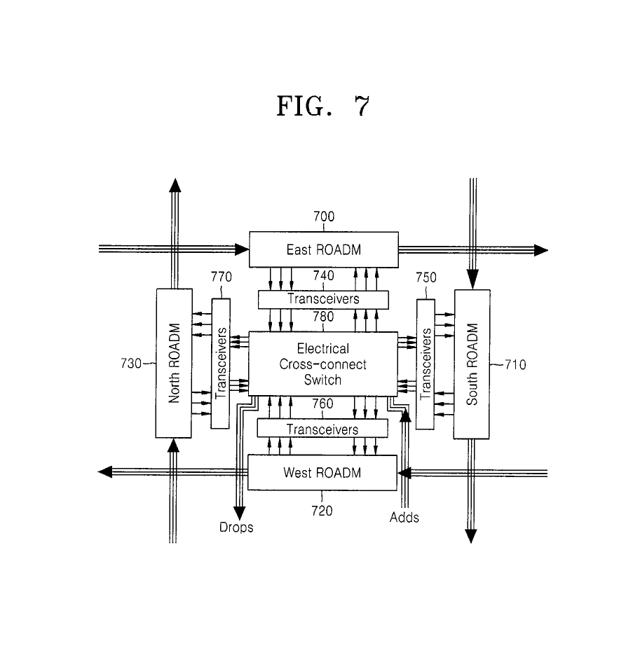

FIG. 7 is a diagram illustrating an optical network node device according to an embodiment of the present invention. In FIG. 7, an example of realizing a node of at least degree 3 by using a planar lightwave circuit (PLC) based or a blocker based reconfigurable optical add drop multiplexer (ROADM) of degree 2.

4-terminals ROADMs 700, 710, 720, and 730 control a wavelength division multiplexing (WDM) channel to pass through, drop, or pass through after adding an optically converted signal to the WDM channel.

Optical transceivers 740, 750, 760, and 770 photoelectrically convert a signal dropped from a corresponding ROADM or optically convert an electric signal transmitted to a corresponding ROADM.

Also, an electrical cross connect switch 780 switches the signal that is photoelectrically converted by the optical transceiver 740, 750, 760, or 770 to one of optical transceivers 740, 750, 760, and 770 corresponding to a direction that the signal will pass through, by redistributing transmission capacity and cross connecting the signal so that the signal is transmitted to a corresponding ROADM.

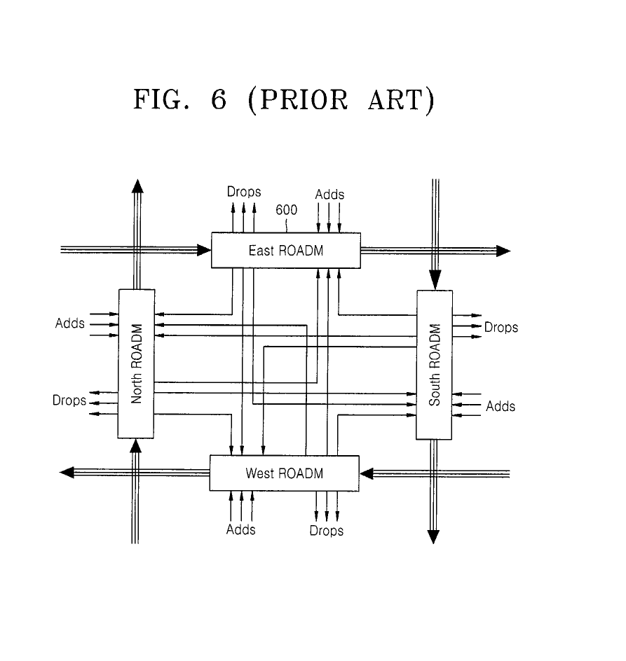

A difference of a node of degree 4 of FIG. 7 is clear when it is compared to the conventional node of FIG. 6. Since the ROADM of FIG. 7 is a PLC based or a blocker based 4-terminals ROADM, the ROADM of FIG. 6 does not include ports that support input/output of an optical fiber from another direction, unlike the WSS based ROADM of FIG. 6. Accordingly, in order to solve such a problem, the electrical cross connect switch 780 is used.

A wavelength channel signal dropped from one of ROADMs 700, 710, 720, and 730 is transmitted to a corresponding optical transceiver, and then converted to an electric signal. The electric signal is inputted to the electrical cross connect switch 780. The electrical cross connect switch 780 can perform aggregation, grooming, or the like on a signal in a unit smaller than a wavelength channel and can redistribute transmission capacity in a unit smaller than a wavelength channel, and can cross connect, drop, or add the signal.

A flow of a signal in FIG. 7 will now be described. A wavelength signal dropped from each of the ROADM 700, 710, 720, and 730 is transmitted to the optical transceiver 740, 750, 760, or 770 corresponding to the ROADM 700, 710, 720, or 730, and is converted to an electric signal. Transmission capacity of the electric signals is redistributed, and the electric signals are cross connected in the electrical cross connect switch 780. Accordingly, a path of a signal is determined, and the signal is transmitted to an optical transceiver that is located on the path.

Then, the signal is received to an optical transceiver that corresponds to the ROADM in the direction of the path. The optical transceiver converts the signal to a wavelength channel signal and added in the ROADM in the direction of the path, and thus the signal is transmitted.

A wavelength channel, which is not required to be proceeded to another direction, is not added/dropped and proceeds by passing through an ROADM.

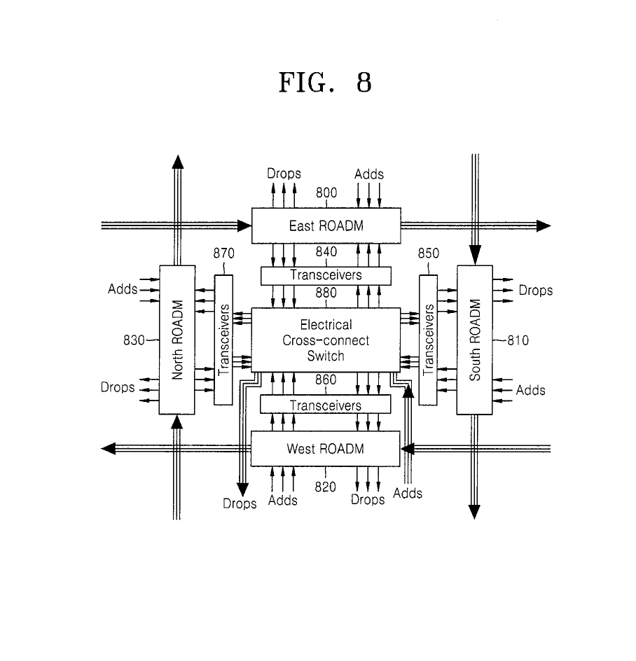

FIG. 8 is a diagram illustrating an optical network node device according to another embodiment of the present invention. Operation and structure of the optical network node device are substantially the same as those of FIG. 7.

A plurality of 4-terminals ROADMs 800, 810, 820, and 830 controls a WDM channel to pass through, drop, or pass through after adding a part of an optically converted signal to the WDM channel.

Optical transceivers 840, 850, 860, and 870 photoelectrically convert a signal dropped from a corresponding ROADM or optically convert an electric signal transmitted to a corresponding ROADM.

Also, an electrical cross connect switch 880 switches the signal that is photoelectrically converted by the optical transceiver to one of optical transceivers 840, 850, 860, and 870 corresponding to a direction that the signal will pass through, by redistributing transmission capacity and cross connecting the signal so that the signal is transmitted to a corresponding ROADM.

The difference between the optical network node device of FIG. 7 and the optical network node device of FIG. 8 is that the ROADM of FIG. 8 outputs another part of the signal, excluding a part of the dropped signal and a part of the added signal, to outside of the optical network node device.

Other signal processing processes are the same as described above with reference to FIG. 7, and thus details thereof will be omitted herein.

For convenience, the present invention is described with an example of a node of degree 4, but it is obvious to one of ordinary skill in the art that the present invention can be applied to a node of at least degree 3.

As described above, an electrical cross connect switch is used to transmit a signal, and the electrical cross connect switch can perform aggregation and grooming of a signal in a unit smaller than a WDM channel. The WDM channel is distributed and connected via an ROADM, and transmission capacity of transmission in a unit smaller than the WDM channel is redistributed and cross connected in the electrical cross connect switch. Accordingly, more efficient configuration of an optical network is possible than a conventional optical network.

Also, it is well known to ordinary skill in the art that each operation of the present invention can be variously realized in hardware and software by using a general programming technology.

According to the optical network node device of the present invention, PLC based or a blocker based 4-terminals ROADM can be used in a node of at least degree 3, a proceeding direction of a wavelength channel can be changed in an electrical cross connect switch, and transmission in a unit smaller than a wavelength channel can be cross connected, dropped, and added, or transmission capacity can be redistributed in the electrical cross connect switch. Accordingly, efficient transmission in a small capacity and large capacity transmission of a wavelength channel can be performed simultaneously, and thus an optical network can be effectively managed. Also, since the node of at least degree 3 uses the PLC based or a blocker based ROADM, the node of at least degree 3 can use the same ROADM module as a node of degree 2. Accordingly, the optical network node device has an advantage in manufacturing and managing a node.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An optical network node device, comprising:
a plurality of 4-terminals ROADM, which controls a wavelength division multiplexing (WDM) channel to pass through, drop, or pass through after adding an optically converted signal to the WDM channel;
optical transceivers, which photoelectrically convert a signal dropped from a corresponding ROADM or optically convert an electric signal transmitted to a corresponding ROADM; and
an electrical cross connect switch, which switches the signal that is photoelectrically converted by the optical transceiver to one of optical transceivers corresponding to a direction that the signal will pass through, by redistributing transmission capacity and cross connecting the signal so that the signal is transmitted to a corresponding ROADM.

2. The optical network node device of claim 1, wherein the ROADM is a planar lightwave circuit (PLC) based or a blocker based ROADM.

3. The optical network node device of claim 2, wherein the ROADM can add or drop the WDM channel in a wavelength channel unit.

4. The optical network node device of claim 1, wherein the number of the ROADM is at least 3.

5. The optical network node device of claim 1, wherein an output wavelength of the electric signal that is optically converted by the optical transceiver is pre-determined or tunable.

6. The optical network node device of claim 1, wherein the electrical cross connect switch performs aggregation and grooming of the photoelectrically converted signal, reproduction of a transmission signal, and reconfiguration and redistribution of WDM channel.

7. The optical network node device of claim 1, wherein the ROADM controls a WDM channel or a signal to pass through, drop, or pass through after adding the WDM channel or the signal, by grasping a path that the WDM channel or the signal is to be transmitted according to information included in the WDM channel or the signal.

8. An optical network node device, comprising:
a plurality of 4-terminals ROADM, which controls a wavelength division multiplexing (WDM) channel to pass through, drop, or pass through after adding a part of an optically converted signal to the WDM channel;
optical transceivers, which photoelectrically convert a part of a signal dropped from a corresponding ROADM or optically convert an electric signal transmitted to a corresponding ROADM; and
an electrical cross connect switch, which switches the signal that is photoelectrically converted by the optical transceiver to one of optical transceivers corresponding to a direction that the signal will pass through, by redistributing transmission capacity and cross connecting the signal so that the signal is transmitted to a corresponding ROADM,
wherein the ROADM outputs another part of the signal, excluding the part of the dropped signal and the part of the added signal, to outside of the optical network node device.

9. The optical network node device of claim 8, wherein the ROADM is a planar lightwave circuit (PLC) based or a blocker based ROADM.

10. The optical network node device of claim 9, wherein the ROADM can add or drop the WDM channel in a wavelength channel unit.

11. The optical network node device of claim 8, wherein the number of the ROADM is at least 3.

12. The optical network node device of claim 8, wherein an output wavelength of the electric signal that is optically converted by the optical transceiver is pre-determined or tunable.

13. The optical network node device of claim 8, wherein the electrical cross connect switch performs aggregation and grooming of the photoelectrically converted signal, reproduction of a transmission signal, and reconfiguration and redistribution of WDM channel.

14. The optical network node device of claim 8, wherein the ROADM controls a WDM channel or a signal to pass through, drop, or pass through after adding the WDM channel or the signal, by grasping a path that the WDM channel or the signal is to be transmitted according to information included in the WDM channel or the signal.
